(19) United States
(12) Patent Application Publication
(10) Pub. No.: US 2003/0140510 A1
(43) Pub. Date: Jul. 31, 2003

(54) Interruption of vehicle compass calibration in response to vehicle accessory interference

(75) Inventors: Ralf David Woods, Fort Wayne, IN (US); Larrie Gould, Fort Wayne, IN (US); Gregory Sullivan, Fort Wayne, IN (US)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens VDO Automotive Corporation

(21) Appl. No.: 10/062,098

(22) Filed: Jan. 31, 2002

(51) Int. Cl. G01C 17/38

(52) U.S. Cl. 33/357

(57) ABSTRACT

An improved vehicle compass calibration obtains magnetic field data measurements from magnetic field sensors mounted in a vehicle. The magnetic field data measurements are stored in memory and, when a sufficient set of data measurements is stored, a calibration calculation attempt is carried out. When a predetermined vehicle accessory that produces a magnetic disturbance is activated, the storage of magnetic field data in memory is interrupted to disable the ongoing collection of data for use in a subsequent calibration calculation while the accessory remains activated.

### BACKGROUND OF THE INVENTION

1. Field of the Invention

The present invention relates to magnetic direction sensing systems for use in vehicles. More particularly, the present invention is directed to a system and method for improving calibration of such magnetic direction sensing systems.

2. Description of the Related Art

Direction sensing systems such as compass devices are widely available as factory-installed components in automobiles and are used to display to the driver and/or other occupants vehicle heading information presented on a display. The display is typically located in either the vehicle dashboard, in the rearview mirror housing or bracket, or in or proximate the vehicle headliner, and operatively conveys the heading direction to the user as one of eight possible directions, e.g., N, S, E, W, NE, NW, SE and SW, corresponding to the directions north, south, east, west, north-east, north-west, south-east and south-west, respectively. Such vehicle compasses employ magnetic field sensors which may be flux gate sensors, magnetoresistors, Hall-effect sensors, etc., to locally sense the magnetic field of the earth. Various processing techniques are then used to account or correct for the vehicular structure or magnetism which produces a differential or deviation between the local magnetic field of the earth and the sensed field as affected by the vehicle in which the sensors are mounted.

To provide accurate heading information, magnetic compasses installed in vehicles must be calibrated in the vehicle to account for the effect of the vehicle magnetic field, which effect will vary depending on the vehicle size, type, and the operating accessories present in the vehicle, e.g. rear windshield defogger, sun roof, hatch back, etc. It is known that vehicles produce a magnetic field due to the presence of ferromagnetic materials, electric current carrying wires, etc. and that this field has a demonstrable effect on the compass magnetic sensor output.

To calculate an initial calibration value, a precalibration technique as described in U.S. Pat. No. 6,047,237 may be employed wherein the initial calibration value at the point of manufacture is based on the particular vehicle model as well as the intended destination of the vehicle, e.g. the geographic location of the vehicle dealership to which the particular vehicle is intended to be shipped. Once such precalibration is complete, more refined compass calibration (such as to account for individual vehicle to vehicle differential among the same vehicle model) utilizing this precalibration data can be performed at the dealership or by the vehicle purchaser, as for example described in U.S. Pat. Nos. 4,546,551 and 6,301,794. To provide improved directional heading accuracy, it is further desirable that additional or updating compass calibration calculations be performed continuously or, at least, periodically, as the user drives the vehicle in normal use.

It is also known that the value of the magnetic field as detected by the magnetic sensors will unintendedly vary due to external magnetic interference from sources both external to and internal to the vehicle. External sources may include, for example, power lines, train lines, bridges, and large metallic structures, etc., and internal sources may include the periodic operation of a vehicle accessory such as an electronic defrosting heater, sunroof, etc. A number of prior art patents disclose methods and systems for preventing or minimizing an erroneous display of directional heading by a vehicle compass device as a result of such interference.

Thus, for example, in the compass system described in U.S. Pat. No. 5,761,094, electric compensation signals are generated to electrically compensate for magnetic sensor error resulting from changes in the sensed magnetic field caused by external forces. U.S. Pat. No. 6,286,221 discloses a controller which generates a magnetic noise correction signal when operation of an internal vehicle accessory is detected to off-set the effects of the resulting electromagnetic noise on the sensors. Likewise, U.S. Pat. No. 5,511,319 discloses a correction circuit for generating correction signals in response to the activation of a vehicle appliance or accessory to off-set electromagnetic field disturbance caused by the appliance. U.S. Pat. No. 5,664,335 discloses a technique wherein a detecting circuit is employed to detect the opening of a vehicle door, which causes an abrupt change in the magnetic field of the vehicle. When this occurs, the magnetic field sensor data is ignored and the displayed direction heading remains unchanged, i.e. the compass continues to report the direction displayed prior to the opening of the vehicle door.

In order to provide improved directional heading accuracy on an ongoing basis, i.e. after initial calibration of the compass at the dealership or by the vehicle purchaser, it is also desirable to carry out additional or updating calibration procedures or calculations as the vehicle is thereafter driven. Recalibration can for example be employed to account for changes in vehicle magnetism that result from additions of or modifications to parts or the structure of the vehicle or to the addition or removal of vehicle operating accessories. Thus, many vehicle compasses permit the user to selectively place the unit in a “calibration mode” so that the user may from time to time effect an intentional recalibration of the device, typically by requiring the user to successively drive the vehicle in specific designated directions or through a predetermined pattern or set of turns. For example, the calibration procedure may require that the user drive the vehicle through a complete or partial circle. This, however, means that the user must cease normal driving and take the time, and find a suitable location (such as an empty parking lot), to carry out the recalibration procedure, a drawback that discourages regular use of this highly useful functionality.

Some vehicle compass systems are accordingly designed to continuously perform ongoing dynamic calibration of the magnetic sensors data whenever the vehicle is driven. In such a system, all detected sensor data as the vehicle is driven in normal use may be applied to a calibration circuit or algorithm so that the unit's calibration can be continuously verified and updated or “tweaked” as indicated as appropriate by the continuously sensed data. The only difficulty with such systems is that magnetic and electromagnetic interference emanating from outside and from within the vehicle ends up being used in the ongoing calibration calculations. While the degree or magnitude of such interference-altered sensor data is generally insufficient to seriously affect the unit's ongoing continuous recalibration, there are some sources of interference that can be particularly significant. For example, the operation of vehicle accessories that require high electrical current draws through vehicle wiring can generate large electromagnetic fields sufficient to virtually overwhelm the far-weaker magnetic field lines of the earth that the sensors are intended to detect. Were such data to be used in recalibrating the compass system, the resulting heading information would likely be notably less, rather than more, accurate than that which was provided before the recalculation.

In an effort to ameliorate this problem, U.S. Pat. No. 4,953,305 teaches a continuous calibration compass that monitors the continuously sensed magnetic field data. When the device detects that a preset threshold of magnetic interference has been met or exceeded by the monitored data, a calibration interrupt is generated to temporarily disable the ongoing calibration function. Calibration is then resumed when the continued monitoring of the sensor data indicates that the above-threshold magnetic interference has ceased. This procedure, however, requires continuous monitoring and evaluation of the sensed magnetic field data at the cost of increased processing overhead and decreased system responsiveness.

### SUMMARY OF THE INVENTION

The present invention is directed to an improved continuously calibrated vehicle compass system wherein calibration susceptibility to magnetic field disturbance generated by vehicle accessory operation is minimized or avoided. This is generally accomplished, in accordance with an embodiment of the present invention, by providing a continuously calibrated compass device having magnetic sensors for detecting the earth's magnetic field and a vehicle's influence on that magnetic field. A processing module is provided for calibrating the compass device from sensor outputs and for presenting data to a display to produce a direction heading to a vehicle operator. The processing module receives, as a control signal input, status information indicating the operation of one or more periodically-operated vehicle accessories which are known to cause at least a threshold or otherwise undesirable amount of magnetic field interference as sensed by the magnetic sensors when the accessories are activated or operated. In response to receipt by the processing module of the control signal input, the automatic continuous calibration calculation routine is temporarily disabled for as long as the control signal input is present so that the calibration calculation is not contaminated by false or erroneous magnetic sensor data. Despite the temporary disabling of the automatic calibration feature, incoming sensor data preferably continues to be used to calculate and display direction heading information by the compass system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1 is a partial perspective view of an interior of an automobile; and

FIG. 2 is a block diagram of the inventive compass with continuous automatic calibration.

### DETAILED DESCRIPTION OF THE PRESENTLY PREFERRED EMBODIMENTS

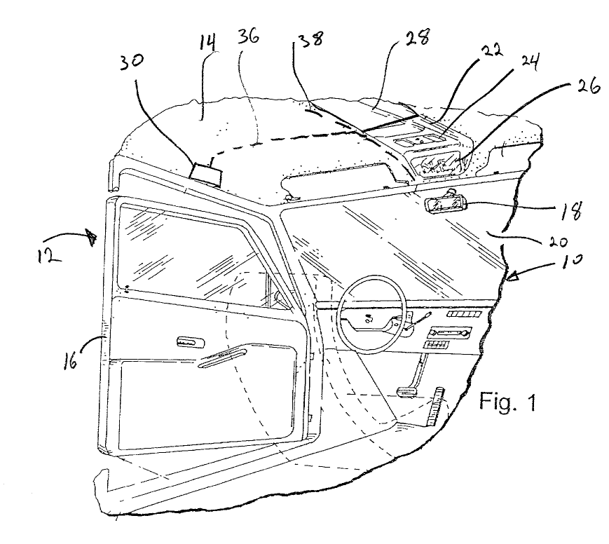

Referring now to the drawings, FIG. 1 depicts a portion of a vehicle 10 defining an interior region 12 having a roof 14 and two or more doors 16. The vehicle 10 includes a rearview mirror 18 preferably mounted to a windshield 20 or to a vehicle headliner 22. Various accessories and operating controls therefor are located in the interior of the vehicle, as is known in the art, such as a rear window defogger (not shown), an audio system having one or more speakers 30, electrically retractable sunroof 28, etc.

The headliner 22 typically supports operating controls and/or components for accessories located at or along or powered by conductors disposed near the vehicle roof, such as the sunroof 28, rear window defogger etc., and a display 26 that is electrically connected, in a known manner, to a compass module 24, a clock (not shown) and a thermometer (not shown) for displaying, by way of illustration, direction heading information, time and/or outside temperature, respectively, to vehicle occupants. The headliner also houses and conceals communication links such as connectors and conductors between a vehicle communications bus (not shown) and the headliner mounted accessories as well as other accessories located throughout the vehicle to provide operating power and other connections to the accessories. For example, as depicted in FIG. 1 conductors 36 provide audio signals to door-mounted speakers 30, conductors 38 provide operating current to a rear window defogger, and other conductors likewise extending within the headliner 22 and along an interior surface of the vehicle roof 14 may carry operating signals and/or current to other accessories located at or proximate the rear of the vehicle, such as a rear entertainment system (DVD player/monitor), rear seat warmer, overhead interior light, etc.

Although the display 26 is shown mounted in or to the headliner 22, it should be recognized that this arrangement is simply a matter of design choice and that the display can alternatively be mounted in any other suitable location within the passenger compartment of the vehicle, such as in or on the dashboard or in a window provided in the rearview mirror 18. Moreover, the illustrated location of the compass module 24 in the headliner is also a matter of design choice and the compass module can alternatively be mounted in other suitable locations throughout the vehicle. It is, however, desirable to locate the compass module magnetic sensors so as to minimize the effect thereon of the vehicle magnetic signature or field and the placement of the sensors near the vehicle roof (such as closely proximate the top of the windshield 20 or in the headliner 22) has been found to be particularly suitable for this purpose.

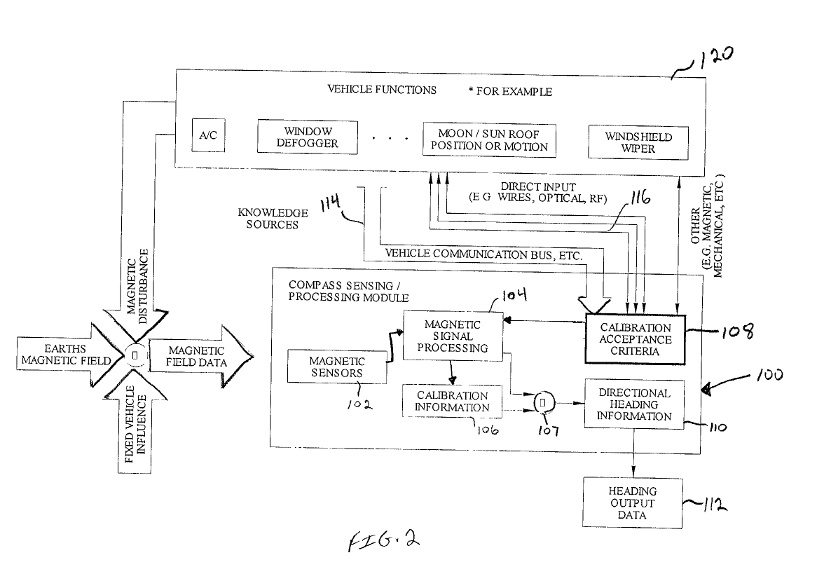

With reference now to FIG. 2, the compass module 100 has a pair of magnetic sensors 102, one oriented orthogonal to the other so that each receives different contributions from the earth's magnetic field flux lines. The outputs of the sensors are provided to a processor, depicted as a magnetic signal processing block 104 which, as explained more fully below, contains the necessary processing instructions and functionality and memory to calculate from the sensor outputs a directional heading and to perform continuous compass calibration in conjunction with calibration information stored in a calibration information block 106. The data values produced by the magnetic signal processing block 104 and the values stored in the calibration information block 106 are combined (as illustrated at node 107) to provide directional heading information at block 110 for illuminating display elements on display 26, e.g. by providing output heading data to heading output data block 112 for illuminating the display to one of “N”, “S”, “E”, etc.

In accordance with the present invention, and as explained below, a calibration acceptance criteria or activation/deactivation control block 108 detects the operation of one or more vehicle accessories which are collectively represented by element 120, and interrupts the automatic calibration process performed by the processor of block 104 to yield a more robust calibration value that avoids or minimizes contamination by vehicle accessory magnetic field disturbances.

The magnetic sensors 102 can be flux-gate sensors, magnetoinductive sensors, magnetoresistive sensors, Hall-effect sensors, or any other device which can sense the earth's magnetic field and provide signals representative thereof to the magnetic signal processing block 104. In a preferred embodiment, a pair of perpendicularly-oriented magnetoresistive sensors are employed, one for sensing in effect the magnetic field in the x-direction (eas-west) and the other for sensing in effect the magnetic field in the y-direction (north-south). To provide accurate directional headings, the compass must be set to account for geographically-dependent differences between magnetic north and directional north, an initial setting effected by selecting one of a plurality of predetermined codes to identify the particular global regional operating location of compass module 24 (i.e. the global regional location of the vehicle 10 in which the compass module is mounted). This is an important initialization step because it is known that the difference between magnetic and true north can greatly vary from one geographic location to another.

The codes corresponding to various geographic regional zones are stored in non-volatile memory on the processor (i.e. in block 104) and the manufacturer or a user (e.g., a car dealership technician, etc.) will initialize the compass module by manually selecting the correct code corresponding to the appropriate geographic zone of use of the vehicle. Once the proper zone has been selected, the compass module uses this zone setting for determination of directional headings by correcting for differential error between true north and magnetic north.

As is known in the art, vehicle compass calibration is performed to account for the variant magnetic field that is caused by the vehicle, i.e. the change in the sensed magnetic field of the earth that results from the magnetic influence of the vehicle. To accomplish this task and to provide an initial calibration starting point when a vehicle is first powered up, thereby causing the compass module to activate, starting values or codes corresponding to a known variant magnetic field of a particular vehicle (i.e. a vehicle make, model, accessory package, etc.), may be used as disclosed in U.S. Pat. No. 6,192,315. A drawback associated with the use of such vehicle-tailored codes, however, lies in inventory control of the modules and, in particular, in the difficulty in placing compass modules having specific codes into their corresponding vehicles or selecting a specific code from a plurality of stored codes to correspond to a specific vehicle. Thus, in a preferred embodiment of the present invention, non-vehicular related initial calibration starting values that are not associated with any particular vehicle are stored in non-volatile memory and are used by the processor to calculate an initial calibration set of data.

Aside from the use of non-vehicular related initial calibration starting values, the technique employed in the present invention for performing continuous calibration of the compass module 24 and for calculating directional heading information based on calibration values is described fully in U.S. Pat. No. 6,014,610, the entire content of which is incorporated herein by reference. In general, and as described therein, a 360° range of possible sensed compass values are distributed among 30 equal 12° segments or bins defined in processor memory, e.g. in magnetic signal processing block 104. As the vehicle 10 is driven and changes direction, the magnetic sensors 102 sense a resultant magnetic field which consists of several components including the earth's magnetic field, the vehicle influence on the earth's magnetic field and, in some circumstances, a magnetic disturbance caused, for example, by the operation of one or more vehicle accessories 120. As for this latter component, the sensors are known to exhibit susceptibility to the activation and/or use of certain vehicle accessories, particularly when the sensors are disposed in proximity to current carrying conductor wires which may provide operating current to the accessories, as depicted for example by the conductors 36 and 38 in FIG. 1. More particularly, when the magnetic sensors are mounted in the headliner and in relatively close proximity to the conductors that provide operating current to a rear window defogger, for example, the electric current communicated by the conductors generate an electromagnetic field that will alter the magnetic field sensed by the sensors. It has been found that a one amp current passing through a wire placed within 0.1 meters from the sensors will generate a magnetic field equivalent to approximately 10% of the earth's horizontal magnetic field, or 0.02 Gauss, which translates directly into compass reading error. In any event, the sensed magnetic field is presented to the processor as a pair of sensor outputs or x, y coordinates (one output for each sensor) and those values are stored in the appropriate memory bins. When all or substantially all of the bins have been filled with data, a calibration calculation attempt is performed by calculating a least-mean-square (LMS) fit of the stored bin data to an expected ellipse and adjusting the offset or drift of the ellipse from the origin of the coordinate system.

Mathematical data from the calculated ellipse equation includes the origin of the ellipse (which is dictated by the magnetic signature of the vehicle while disregarding the signature effect on the earth's magnetic field); the ellipse size (which is dictated by the vehicle geographic location and vehicle magnetic signature influence on the earth's magnetic field at the present geographic location); the sine and cosine functions of the ellipse; and the ellipse flattening and rotational parameters. This data is compared with the then-current calibration data parameter set that is stored in processor memory and represented in FIG. 2 by the calibration information block 106. In the event that the new calibration attempt data differs from that currently being used and is deemed acceptable on the basis of certain criteria, the prior calibration values are discarded and the new values are stored in block 106. Otherwise, the prior calibration values are maintained until a new acceptable calibration is available. In either case, the data in the memory bins will be discarded and, as the vehicle is further driven, replaced with new sensor measurements for use in a next calibration attempt when sufficient data has been stored in the bins.

In a preferred embodiment, a time limit is set during which all of the bins necessary for a calibration calculation attempt must be filled. Thus, if the time limit period expires before the bins are supplied with data, which may occur if the vehicle travels along a straight path for longer than the set time limit, or if the vehicle is turned off during the gathering of possible calibration data, then all of the existing data in the bins will be discarded and more recent (i.e. current) magnetic sensor output data will be used to again commence filling of the bin memory locations.

Once a calibration measurement is stored in processor memory, outputs from the magnetic sensors are compared to the calibration measurement (depicted at node 7 in FIG. 2) and a vehicle directional degree heading is calculated by the processor to provide directional heading information (block 110) in a manner well known to those of ordinary skill in the art. The degree heading is then converted into one of eight direction indicators, namely, one of either N, S, E, W, NE, NW, SE and SW, by dividing all of the possible 360° values into sectors and, as is preferred, eight equal sized 45° sectors. The calculated degree heading is for example compared to a look-up table stored in processor memory from which the processor selects a corresponding direction indicator, such as is more fully described in U.S. Pat. No. 5,333,110, for causing display 26 to conventionally display the calculated direction to the vehicle occupants.

As the vehicle continues to be driven along varying directions, the magnetic sensors 102 continue to output magnetic field data. However, when activation of a vehicle accessory causes interference with the sensors, such as when one or more of a rear window defogger, sunroof, windshield wipers, etc. is activated, the magnetic disturbance component generated by the activated accessory will cause the sensors 102 to incorrectly sense the magnetic field of the vehicle and the earth. For example, it has been demonstrated that activation of an electric rear window defogger can create an error in magnetic sensor output. If this incorrect or inaccurate data is used to fill the memory bins for use in executing a calibration attempt, the resulting calibration data will be unreliable.

To prevent compass calibration attempts based on such erroneous data, a calibration acceptance criteria function block 108 is provided. This function detects the activation or operation of certain predetermined accessories and/or other vehicle components that are known to cause an unacceptable disturbance of the magnetic field as seen by the sensors and which, upon detection, temporarily disables the continuous calibration function—i.e. ceases the placement of sensed data in the storage bins—by providing a command signal to the processor 104. Thus, the calibration acceptance criteria block 108 may detect the activation or operation of the rear window defogger, in which case the calibration routine will be interrupted while the defogger remains active. This interruption may occur at any time during the storage of calibration data, e.g., when any number of the memory bins contain sensor data entries. When the accessory is no longer activated, the calibration function is again enabled to either continue to store additional sensor data in the memory bins as discussed above or, in the event that a “time out” feature is employed and the accessory activation time has exceeded the time out period, to discard existing memory bin entries and then store new sensor data.

In preferred embodiments of the invention the detection of accessory operation is effected by monitoring of the vehicle communication bus 114. In modern vehicles, all operating accessories and other operating parts and components of the vehicle are generally connected to the bus 114, including the vehicle compass. In accordance with the present invention, those accessories and other vehicle components that generate magnetic or electromagnetic fields of sufficient strength or location (relative to the compass sensors) to notably perturb the sensor outputs are identified, as for example by the manufacturer of the vehicle. In addition, accessories or components that normally would not greatly disturb the sensor outputs but which for other reasons—as for example because, when operated, they draw or direct electrical current through wires that are located in close proximity to the sensors—are similarly identified. Whenever one or more of these so-identified or predetermined vehicle accessories or components is activated or otherwise operating, a signal so indicating the same will be placed on the vehicle bus and thereby received by the compass module which monitors the vehicle bus for such signal. For example, the vehicle bus can carry a particular signal or token, such as a hexadecimal “FF”, whenever any of the predetermined accessories or components is activated or in operation; whenever the compass module detects the presence of the “FF” token on the bus 114, no additional sensor data is directed to the storage bins from which data for calibration attempts is drawn. When the “FF” token is no longer detected on the bus 114, new incoming sensor data is again directed to the appropriate storage bins for use in a subsequent calibration effort. Activation of individual ones of the predetermined operating accessories or components can alternatively be indicated on the vehicle bus by signals or tokens unique to each accessory or component to enable the compass module to identify the particular accessory or component that has been activated.

Moreover, although it is currently preferred that detection by the compass module of the fact of activation or operation of one or more of the predetermined vehicle accessories or components be effected through monitoring of the system bus 114, it is also within the intended scope and contemplation of the invention that such detection be carried out through direct connections between the individual predetermined accessories or components and the compass module or, similarly, through a common compass module interface to which some or all of the predetermined accessories and components are individually connected for similarly notifying the compass module of their operating status. For example, direct communication to individual accessories or components may be provided through dedicated connection wiring 116 or, alternatively, other types of sensing techniques may be employed to detect when a particular predetermined vehicle accessory or component is activated, such as by the closing or opening of magnetic switches, infrared detectors, magnetic sensing, etc.

During the time that the continuous calibration function of the compass is disabled due to operation of a predetermined vehicle accessory or component, heading information will preferably continue to be displayed to the vehicle occupants via the heading display 26 based on received sensor data. Although the heading display sensor outputs while a particular magnetic disturbance accessory is activated will not be as accurate as when no such field disturbance is present, it will still in most instances be sufficiently acceptable for normal vehicle operator use. Since each performed directional display sector corresponds to a 45° wide swath, a magnetic sensor measurement deviation of as much as 10° (such as in the event of a rear defogger activation) or more will typically maintain the direction displayed on the compass display 26 within the same sector. In any event, such variations are normally acceptable for the typical use of an in-vehicle compass, especially since the deviation condition will likely exist for only a relatively short duration of time, i.e. until the magnetic field disturbance accessory is deactivated. Of course, certain accessories may produce an unacceptable level of magnetic interference in which case, when the activation of such accessories are detected, the display may be temporarily disabled or a correction signal may be generated to offset the magnetic interference so that heading displays can continue.

Thus, while there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A vehicle electronic compass system for determining a heading of a vehicle as a function of the earth's magnetic field, said vehicle having an associated magnetic signature and an accessory which causes a magnetic disturbance when activated, said system comprising:
a magnetic sensor for sensing the earth's magnetic field and producing sensor output data values;
a processor having a calibration function for calculating a set of calibration parameters from the sensor output data values for calibrating the compass system to account for an influence of the vehicle magnetic signature on the earth's magnetic field, and for providing vehicle heading information to a vehicle display; and
means for detecting the activation of said accessory and for disabling said calibration function of the processor so that a calibration calculation is not performed on sensor output data values obtained during activation of said accessory.

2. The vehicle electronic compass system of claim 1, wherein said processor comprises a memory having a plurality of memory storage bins for receiving sensor output data values and for storing parameters of a prior-calculated calibration.

3. The vehicle electronic compass system of claim 2, wherein said processor comprises means for comparing said set of calibration parameters to said prior-calculated calibration parameters for determining which one of said parameter sets should be retained.

4. The vehicle electronic compass system of claim 2, wherein said calibration finction is activated when at least most of said memory storage bins are assigned sensor output data values.

5. The vehicle electronic compass system of claim 2, wherein said calibration function is activated when at least most of said memory storage bins are assigned sensor output data values within a predetermined time interval.

6. The vehicle electronic compass system of claim 1, wherein said magnetic sensor comprises a pair of magnetoresistive sensors.

7. The vehicle electronic compass system of claim 6, wherein said vehicle comprises a headliner and wherein said pair of sensors are housed in said headliner.

8. The vehicle electronic compass system of claim 1, wherein said detecting means further comprises means for enabling said calibration function when the activation of said accessory is no longer detected.

9. The vehicle electronic compass system of claim 1, wherein said detecting means is connected to a vehicle communication bus.

10. An improved calibration system for a vehicle electronic compass for determining a heading of a vehicle as a function of the earth's magnetic field, the vehicle having an associated magnetic signature and an accessory which generates a magnetic disturbance when activated, the vehicle electronic compass having a magnetic sensor for sensing the earth's magnetic field and producing sensor output data values, and a processor having a calibration function for calculating a set of calibration parameters from the sensor output data values for calibrating the electronic compass to account for an influence of the vehicle magnetic signature on the earth's magnetic field, said improvement comprising:
means for detecting the activation of the accessory and for disabling the calibration function of the processor so that a calibration calculation is not performed on sensor output data values obtained during activation of the accessory.

11. The improvement of claim 10, wherein said detecting means further comprises means for re-enabling said calibration function when the activation of the accessory is no longer detected.

12. The improvement of claim 10, wherein said detecting means is connected to a vehicle communication bus.

13. A method for disabling a calibration function of a vehicle electronic compass system including a magnetic sensor mounted in a vehicle, said vehicle having a magnetic signature and an accessory which causes a magnetic disturbance when activated, said compass system providing vehicle direction heading information to a vehicle operator, said method comprising the steps of:
sensing a magnetic field of the earth by the magnetic sensors and outputting sensed magnetic field data values;
storing said data values in memory locations for use in calculating a set of compass calibration parameters;
detecting activation of the accessory; and
upon said detecting of accessory activation, disabling said storing in the memory locations of magnetic field data values that are output by said sensing step while said accessory remains activated.

14. The method of claim 13, further comprising the step of re-enabling said storing of magnetic field data values in the memory locations when said accessory is no longer activated.

15. The method of claim 14, further comprising the step of performing a calibration calculation when a predetermined sufficient number of the memory locations contain stored magnetic field data values.

16. The method of claim 15, further comprising the step of discarding the stored magnetic field data when a time interval during which magnetic field data values are provided for storing in said predetermined sufficient number of memory locations exceeds a predetermined time interval.

17. The method of claim 13, further comprising the step of supplying vehicle heading information to a display while the accessory is detected as being activated.
